(19) United States
(12) Patent Application Publication
(10) Pub. No.: US 2026/0034999 A1
(43) Pub. Date: Feb. 5, 2026

(54) Modular Zonal Controller for Vehicle

(71) Applicant: Karma Automotive LLC, Irvine, CA (US)

(72) Inventors: Atul Deshpande, Irvine, CA (US); Nicholas Quinn, Irvine, CA (US); Ali Sherifi, Irvine, CA (US); Bin Liu, Irvine, CA (US)

(73) Assignee: Karma Automotive LLC, Irvine, CA (US)

(21) Appl. No.: 18/795,128

(22) Filed: Aug. 5, 2024

(51) Int. Cl. B60W 50/06; B60R 16/023; G08C 17/02

(52) U.S. Cl. CPC B60W 50/06; B60R 16/0231; B60W 2050/065; B60W 2556/45; G08C 17/02

(57) ABSTRACT

A method includes receiving an identification signal from a bridge module associated with a component of a vehicle. Responsive to receiving the identification signal, the method also includes retrieving a command list and a dependency list associated with the component. Responsive to detecting a selected dependency of the dependency list, the method also includes transmitting a command of the command list corresponding to the selected dependency to the bridge module. The command when received by the bridge module causes the bridge module to control an operation of the component.

### TECHNICAL FIELD

This disclosure relates to zonal controllers for vehicles, and more particularly, to modular zonal controllers configurable based on associated vehicular components.

### BACKGROUND

Vehicles rely on a myriad of independent microcontroller unit (MCU)-based controllers to implement functions across the vehicle. Often, these controllers are unique devices equipped with more hardware and processing power than necessary to execute their vehicular function. Zonal controllers typically consolidate processing power and fulfill multiple functions from a single module with little wasted space, processing, and hardware. That is, implementing zonal controller architecture enables the ability to provide efficient power and data distribution around the vehicle, while improving wire cost, weight, and manufacturing costs.

However, because each vehicle has a different set of needs and each zone within a vehicle also has different needs, zonal controllers are traditionally designed to fulfill the content requirements for one specific zone of one specific vehicle platform. This means that the design of a zonal controller typically is modified or redone for new platforms or potentially for new content on existing platforms. While creating zonal controllers with massive amounts of input/outputs (IO) to be generic enough to capture the needs of any zone platform is possible, the result is the overcrowding of controllers that have wasteful components and/or wasted space on their printed circuit boards (PCBs). These overly generic zonal controllers are typically still redesigned to add new content if either a new processor or connection type is required.

### SUMMARY

One aspect of the disclosure provides a computer-implemented method that when executed on data processing hardware causes the data processing hardware to perform operations. The operations include receiving an identification signal from a bridge module associated with a component of the vehicle. Responsive to receiving the identification signal, the operations include retrieving a command list and a dependency list associated with the component. Responsive to detecting a selected dependency of the dependency list, the operations include transmitting a command of the command list corresponding to the selected dependency to the bridge module. The command causes the bridge module to control an operation of the component.

Implementations of the disclosure may include one or more of the following optional features. In some implementations, the bridge module transmits the identification signal responsive to receiving an identification request from a shore module. In further implementations, the shore module transmits the identification request to the bridge module responsive to detecting installation of the bridge module at the vehicle. In other further implementations, the bridge module is one bridge module of a plurality of bridge modules connected to the shore module. In other even further implementations, the shore module and the plurality of bridge modules are operable to control operation of a plurality of components of the vehicle. Each bridge module of the plurality of bridge modules is associated with one or more respective components of the plurality of components. In additional further implementations, the shore module is associated with a zone of the vehicle. Each bridge module of the plurality of bridge modules is associated with one or more respective components corresponding to the zone of the vehicle.

In some examples, the command list and the dependency list are retrieved wirelessly from a remote server.

In some aspects, detecting the selected dependency includes detecting a signal associated with the operation of the component on a communication network of the vehicle. In some implementations, the bridge module is connected to a communication network of the vehicle.

In some examples, the bridge module includes a microcontroller unit (MCU) operable to control the operation of the component.

Another aspect of the disclosure provides a vehicle including memory hardware that stores instructions. The instructions, when executed on data processing hardware in communication with the memory hardware, cause the data processing hardware to perform operations. The operations include receiving an identification signal from a bridge module associated with a component of the vehicle. Responsive to receiving the identification signal, the operations include retrieving a command list and a dependency list associated with the component. Responsive to detecting a selected dependency of the dependency list, the operations include transmitting a command of the command list corresponding to the selected dependency to the bridge module. The command causes the bridge module to control an operation of the component. This aspect may include one or more of the following optional features.

In some implementations, the bridge module transmits the identification signal responsive to receiving an identification request from a shore module. In further implementations, the shore module transmits the identification request to the bridge module responsive to detecting installation of the bridge module at the vehicle. In other further implementations, the bridge module is one bridge module of a plurality of bridge modules connected to the shore module. In other even further implementations, the shore module and the plurality of bridge modules are operable to control operation of a plurality of components of the vehicle. Each bridge module of the plurality of bridge modules is associated with one or more respective components of the plurality of components. In additional further implementations, the shore module is associated with a zone of the vehicle. Each bridge module of the plurality of bridge modules is associated with one or more respective components corresponding to the zone of the vehicle.

In some examples, the command list and the dependency list are retrieved wirelessly from a remote server.

In some aspects, detecting the selected dependency includes detecting a signal associated with the operation of the component on a communication network of the vehicle. In some implementations, the bridge module is connected to a communication network of the vehicle.

In some examples, the bridge module includes a microcontroller unit (MCU) operable to control the operation of the component.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example vehicle including a zonal controller architecture.

FIG. 2 is a schematic view of a modular zonal controller of the vehicle.

FIG. 3 is a side view of the zonal controller.

FIG. 4 is a schematic view of a standardized connector interface between a bridge module and a shore module of the zonal controller.

FIGS. 5 and 6 are perspective views of the bridge module, including example dimensions of the bridge module.

FIG. 7 is a perspective view of the zonal controller, including example dimensions of the zonal controller.

FIG. 8 is a flowchart of an example arrangement of operations for a method of configuring the zonal controller when one or more bridge modules having connected vehicle components are installed at the shore module of the zonal controller.

FIG. 9 is a schematic view of an example computing device that may be used to implement the systems and methods described herein.

Like reference symbols in the various drawings indicate like elements.

### DETAILED DESCRIPTION

In contrast to a domain architecture in which vehicle systems are grouped by function, a vehicle implementing a zonal architecture offers a more efficient solution by grouping functions within a vehicle into several zones. Here, each zone in a zonal architecture includes a respective set of devices that are installed in a particular section of the vehicle and are connected to a respective locally installed zonal controller or gateway. The respective set of devices associated with each zone of the zonal architecture and in communication with the respective zonal controller may include sensors and/or actuators such as, without limitation, light devices, air conditioning, suspension, electronics, parking assistance, batteries, inverters/motors, an engine, power steering components, power braking components, and radios including ultra wideband radios.

Because the zonal controller is close to the devices it controls and/or communicates with, the communication paths (e.g., cables or wireless communications) are relatively short. In the zonal architecture, each zonal controller is connected to a central controller/computer that may have supervisory control over all of the zones and may be responsible for facilitating communications between the vehicle and devices/entities remote from the vehicle. As a result, the communication between zonal controllers and the central controller resembles that of a computer network rather than an automotive harness, thereby enabling the inter-zonal communication to occur over a small, high-speed networking cable that greatly reduces the quantity and size of the cables that must be installed around the vehicle.

To accommodate the differences in functionality and the various vehicular components corresponding to each zone of the vehicle, each zonal controller is configured to perform a unique set of processing and driving functions via software operating on specifically configured electronic circuitry. In other words, each zonal controller is configured to control operation of the vehicular components corresponding to the zonal controller's associated zone, with the construction of the zonal controller (e.g., memory hardware and/or data processing hardware of the zonal controller) tailored to the needs of its zone. As discussed further below, a modular zonal controller separates the processing and driving components of the controller to allow the zonal controller to fulfill the content requirements of its zone and vehicle platform by adding and/or removing driving components from the zonal controller. Further, the modular zonal controller enables upgrades as the processing module and/or driving module can be changed or swapped.

In other words, the modular zonal controller includes a primary or shore module and one or more secondary or bridge modules that are connected to the shore module and that receive connectors for one or more vehicle components. The bridge modules are specifically configured to control the one or more connected vehicle components and are selected for attachment to the shore module based on the assigned vehicle zone of the shore module. Once the bridge modules and/or vehicle components are connected to the shore module, the shore module retrieves instructions for operating the bridge modules and/or vehicle components. Thus, the hardware and software of the modular zonal controllers are configurable based on the connected vehicle functions and assigned vehicle zone of the controller, thereby reducing wasted processing resources and/or PCB space and improving flexibility of use of the zonal controllers across vehicle platforms.

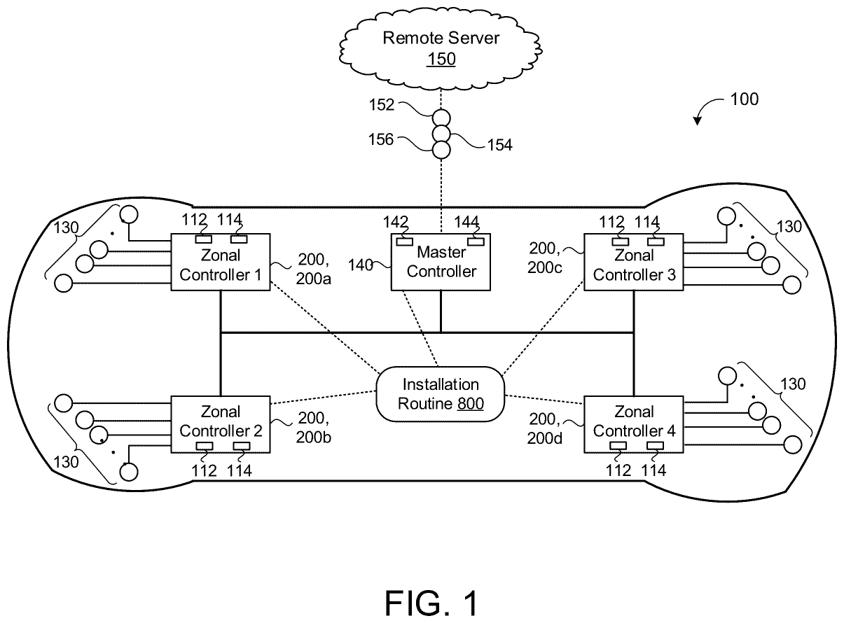

Referring to FIG. 1, in some implementations, a vehicle 100 implements a zonal architecture that includes a plurality of zonal controllers 200, 200a-n for grouping functions within the vehicle into specific zones. Namely, each zonal controller 200 is assigned to a respective zone of the vehicle 100 and is connected to a respective set of components 130 that are installed in or near the respective zone the zonal controller 200 is assigned. In the example shown, each zonal controller 200 is locally installed in the respective zone of the vehicle 100 in which the respective set of components 130 are installed. For instance, a first zonal controller 200a is installed on a front passenger-side zone, a second zonal controller 200b is installed in a front driver-side zone, a third zonal controller 200c is installed in a rear passenger-size zone, and a fourth zonal controller 200d is installed in a rear driver-side zone. Other configurations are possible as well. For instance, a respective zonal controller may be assigned to each one of a front zone including respective components 130 installed on the front of the vehicle, a first side zone including a respective set of components 130 installed on a right side or left side of the vehicle, a second side zone including a respective set of components installed on the other one of the right side or the left side of the vehicle, and a rear zone including a respective set of components 130 installed on a rear of the vehicle. The number of zonal controllers 200 is non-limiting such that the vehicle 100 may equally include less than four zonal controllers 200 or more than four zonal controllers 200 without departing from the scope of the present disclosure.

The respective set of components 130 associated with each zone of the zonal architecture and in communication with the respective zonal controller 200 may include sensors and/or actuators. For instance, the respective set of components 130 may include, without limitation, sensors, lights, actuators, heating ventilation and air conditioning (HVAC) systems, steering systems, brakes, parking brakes, safety devices (airbag controls devices, vehicle dynamic control (VDC) devices, electronic stability control (ESC) devices, etc.), suspension devices, power windows, power trunks/lift gates, electronics, parking assistance systems, batteries, inverters/motors, an engine, cameras, and communication interfaces. Since each zonal controller 200 is close to the components 130 it controls and/or communicates with, the communication paths (e.g., cables or wireless communications) are relatively short.

In the zonal architecture, each zonal controller 200 is in communication with the other zonal controllers 200 and a master controller 140 that acts as a central controller having supervisory control over all the zones and may be responsible for facilitating communications between the vehicle and devices/entities remote from the vehicle. The zonal controllers 200 and the master controller 140 may communicate with one another via a CAN bus, LIN bus, Ethernet, and/or other communication paths. Wireless communication paths are also possible. Each zonal controller 200 may communicate with the respective set of components 130 via any wired or wireless communication protocol such, as without limitation, CAN, LIN, or Ethernet.

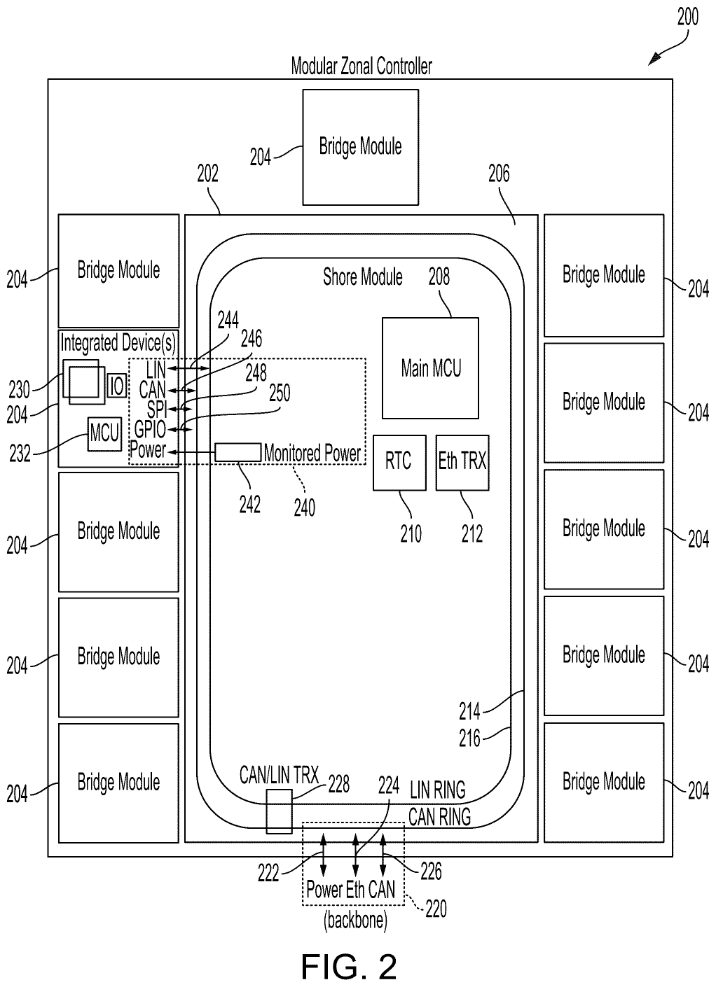

Each zonal controller 200 in the zonal architecture may include respective data processing hardware 112 and respective memory hardware 114 in communication with the data processing hardware 112. The memory hardware 114 may store instructions executable on the respective data processing hardware 112 that causes the data processing hardware to perform operations for controlling the functionality of the respective set of components 130. In some examples, each zonal controller 200 is capable of executing a setup or installation routine 800 on the data processing hardware 112 for configuring the zonal controller 200 based on the respective set of vehicle components 130 connected to and/or associated with the zonal controller 200. Described in greater detail below, each zonal controller 200 is a modular unit having a shore module 202 (FIG. 2) and one or more bridge modules 204 (FIG. 2), where each bridge module 204 connects between one or more components 130 in the assigned zone of the zonal controller 200 and the shore module 202, and the shore module 202 receives instructions for operating the one or more components 130 responsive to connecting to the bridge module 204.

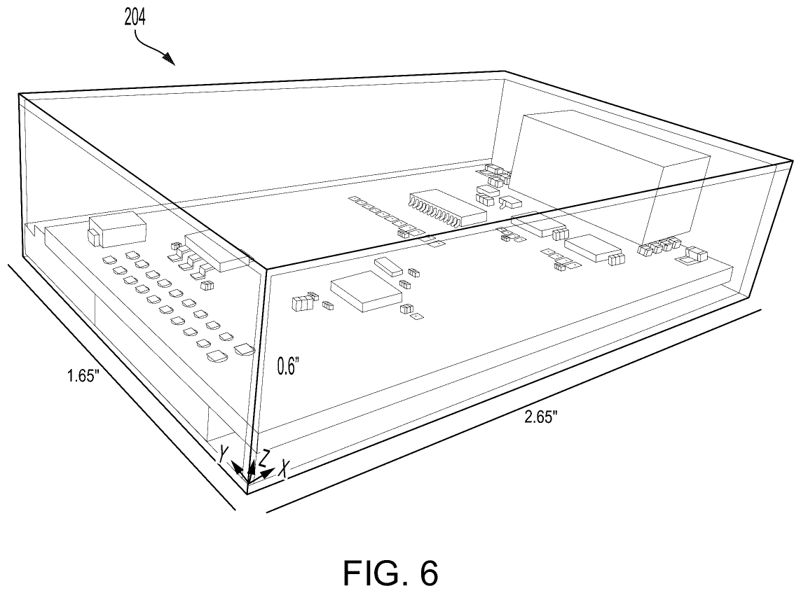

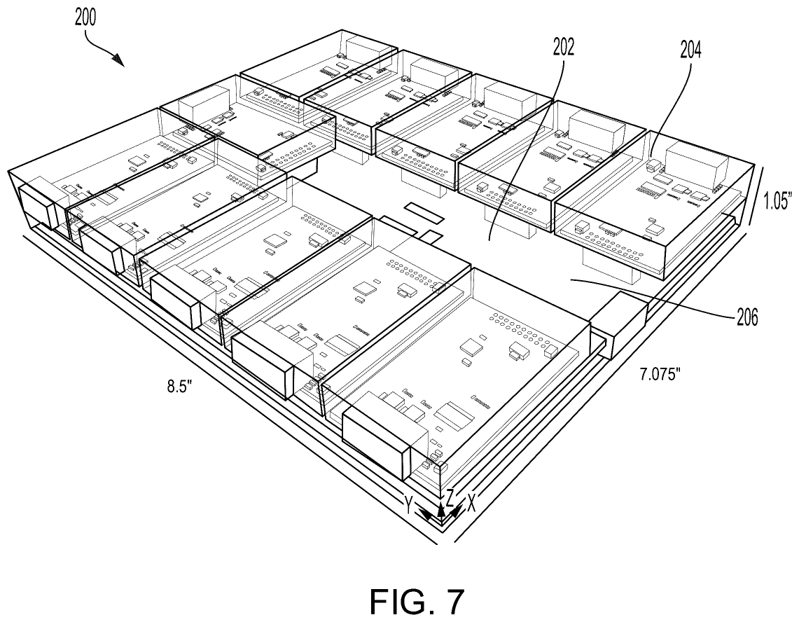

Referring to FIGS. 2-7, each zonal controller 200 includes the shore module 202 and the one or more bridge modules 204. The shore module 202 includes main processing and networking elements that handle connection to the vehicle network (e.g., the vehicle CAN bus, LIN bus, or Ethernet communication pathways) and distributing tasks to relevant bridge modules 204. For example, the shore module 202 includes a printed control board (PCB) 206 that accommodates a main control module or main microcontroller unit (MCU) 208, such as for processing signals received over the vehicle network and generating commands for bridge modules 204 and/or vehicle components 130. The shore module 202 further includes a real-time clock (RTC) module 210, such as for synchronizing operation across the zonal controllers 200 and/or vehicle components 130, and a communication module 212, such as an Ethernet transformer, for communicating with the vehicle network.

The CAN and LIN buses are brought into the zonal controller 200 through internal traces of a CAN ring 214 and a LIN ring 216 formed on the PCB 206 of the shore module 202. The CAN ring 214 and the LIN ring 216 branch off to each bridge module 204 to allow the bridge modules 204 to be respectively connected to the bus. Further, splicing of the CAN and LIN bus occurs within the bridge module 204, and prevents the need for external splicing of the CAN and LIN buses. The shore module 202 includes a connector 220 with power input 222, an Ethernet connector 224 for connection to the vehicle network, and a redundant CAN bus 226 for pass-through to the bridge modules 204. A CAN and/or LIN transformer 228 is disposed on the shore module PCB 206 for connection of the shore module 202 to the CAN ring 214 and/or the LIN ring 216.

Because the CAN bus and/or LIN bus of the vehicle 100 are in direct communication with the bridge module 204 as well as the shore module 202, operation of the connected vehicle components 130 can be controlled via redundant communication interfaces. That is, in the event of failure of the shore module 202 and/or the bridge module 204, operation of the vehicle component 130 may still be achieved over the vehicle network. This ensures that critical vehicle components 130 (e.g., sensors, light modules, steering components, braking components, and the like) may remain functional in the event of component failure.

Bridge modules 204 contain application-specific hardware 230 controlled by an MCU 232. The MCU 232 controls operation of the vehicle components 130 connected to the bridge module 204 through the drivers 230 based on signals received from the shore module 202 and/or via the vehicle network. Thus, the bridge module 204 may act as a serial peripheral interface (SPI) general purpose input output (GPIO) expander with additional functionality. The hardware 230 of each bridge module 204 may be specifically configured for the respective set of components 130 in the corresponding zone of the vehicle 100 that is associated with the zonal controller 200. For example, the first zonal controller 200a may be disposed at a front zone of the vehicle and one bridge module 204 of the first zonal controller 200a may be configured to control respective lighting modules (e.g., a headlamp, a turn signal indicator, a running light, a fog light) at the front zone of the vehicle 100 while another bridge module 204 of the first zonal controller 200a may be configured to control the HVAC system of the vehicle 100. The two bridge modules 204 may have differently configured hardware 230 based on the functionality operated via the bridge module 204. Accordingly, the one or more bridge modules 204 disposed at the shore module 202 are each selected and connected to the shore module 202 based on the components 130 operated by the zonal controller 200.

Put another way, the zonal controller 200 includes a plurality of bridge modules 204 connected to the shore module 202. The shore module 202 may be associated with a corresponding zone of the vehicle 100, and the shore module 202 and the plurality of bridge modules 204 operate to control a respective plurality of vehicle components 130 assigned to the zone. Each bridge module 204 may be associated with one or more of the respective components 130 and particularly configured to control operation of those components 130. To configure the zonal controller 200 for another zone of the vehicle 100 (or a different vehicle platform), a different set of bridge modules 204 may be connected to a shore module 202.

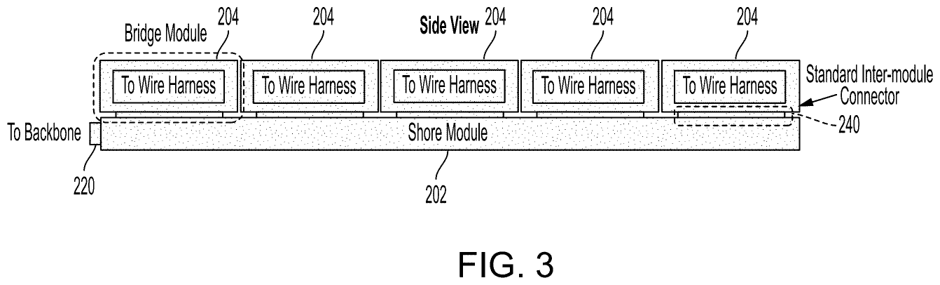

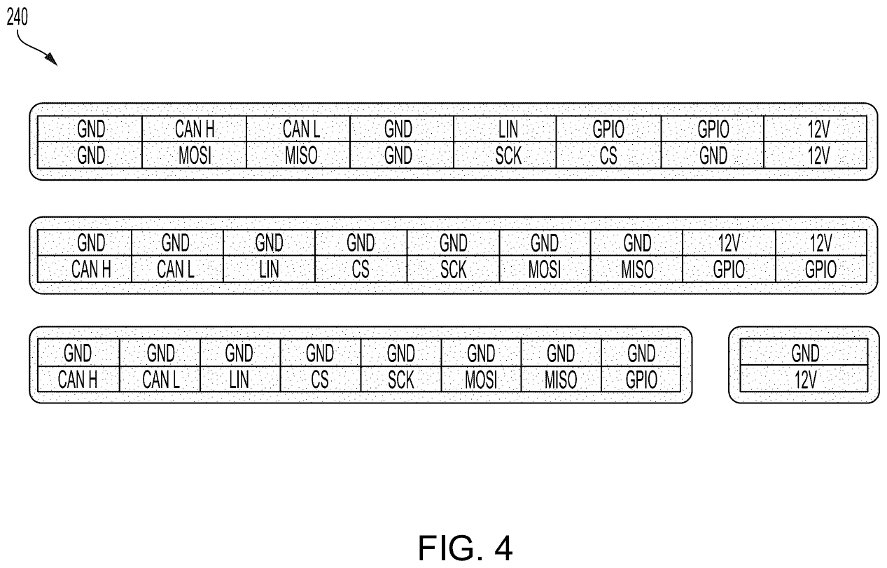

Each bridge module 204 connects to the shore module 202 via a respective connector interface 240, where the connectors at the bridge module 204 and the shore module 202 are standardized to allow for connection of differently configured bridge modules 204 at the shore module 202 (FIGS. 3 and 4). That is, bridge modules 204 having differently configured hardware 230 may connect to the shore module 202 using the standardized connector interface 240. The connector interface 240 may include a set of pins or blades 242 for power and power ground connection between the bridge module 204 and the shore module 202 and one or more communication ports. For example, the connector interface 240 includes a LIN connector 244 and a CAN connector 246 that connect to the shore module 202 and/or the CAN ring 214 and/or the LIN ring 216 for pass-through to other components 130 and for redundant communication between the master controller 140 and bridge modules 204 associated with, for example, safety features of the vehicle or other high priority components 130. A SPI connector 248 of the connector interface 240 may operate as a primary communication link between the shore module 202 and the bridge module 204. A GPIO connector 250 may operate primarily as an interrupt from the bridge module 204. Thus, the bridge module 204 interfaces with the shore module 202 using a standardized connector interface 240 to allow for quick and simple exchange of various bridge modules 204 at the shore module 202 and thus reconfiguration of the inputs/outputs (IOs) of the shore module 202 to the vehicle components 130.

With reference to FIGS. 1 and 2, during the installation routine 800, the shore module 202 may identify bridge modules 204 connected to the shore module 202 and retrieve instructions for operating associated vehicle components 130, such as from a remote server 150 in communication with the vehicle 100. The shore module 202 may communicate with the remote server 150 directly, or the zonal controller 200 may communicate with the remote server 150 via the master controller 140 of the vehicle 100. Upon connection of the bridge module 204 (having one or more connected vehicle components 130) to the shore module 202, the shore module 202 transmits a request identifier SPI message to the bridge module 204. The shore module 202 is equipped with open load detection on its power feed to the bridge module 204 via the connection interface 240 to allow the shore module 202 to detect whether the bridge module 204 is connected.

Upon receiving the request identifier message, the bridge module 204 responds to the shore module 202 with a unique identifier 152. The unique identifier 152 allows the shore module 202 to determine the application-specific design of the bridge module 204, meaning that the shore module 202 may determine the capabilities of the bridge module 204 and/or determine the vehicle components 130 connected to the bridge module 204. Moreover, the identification system causes the shore module 202 to retrieve relevant operating software for controlling operation of the bridge module 204 and/or connected vehicle components 130. For example, the shore module 202 may transmit the unique identifier 152 (and/or a request based on the unique identifier 152) to the remote server 150 to retrieve a command list 154 and a dependency list 156 associated with one or more vehicle components 130 connected to the bridge module 204.

The command list 154 may identify respective commands for operating the vehicle components 130 while the dependency list 156 may identify respective dependencies associated with the commands and that cause the zonal controller to execute the commands. For example, the dependency list 156 may include signals transmitted over the vehicle network (e.g., a request to activate a turn signal of the vehicle 100) and based on the shore module 202 detecting a dependency of the dependency list 156, the shore module 202 instructs the bridge module 204 to execute the associated command of the command list 154 (e.g., activating the turn signal).

In some examples, the command list 154 and/or the dependency list 156 may be transmitted from the bridge module 204 to the shore module 202. That is, the bridge module 204 may be programmed prior to connection to the shore module 202 and thus the bridge module 204 communicates with the shore module 202 the command list 154 containing SPI commands that correspond to actions by the bridge module 204 and that are dependent on specific network messages identified by the dependency list 156.

Thus, auto-identification of the application-specific bridge module 204 and associated firmware via wireless connection to the remote server 150 allows for plug-and-play capability of the zonal controller 200. That is, during installation at the vehicle 100, a user may plug one or more discrete vehicle components 130 into a bridge module 204. Once the bridge module 204 connects to the shore module 202, the shore module 202 identifies the bridge module 204 and the assigned software (e.g., the command list 154 and/or the dependency list 156) may be downloaded to the shore module 202 and/or bridge module 204. After the software is retrieved, functionality of the vehicle components 130 may be used.

When swapping a component 130 connected to the zonal controller 200, such as to replace the component 130 of the vehicle 100 (e.g., install new headlights at the vehicle 100) or to adjust the zonal controller 200 for use with another vehicle platform, the bridge module 204 associated with the old component 130 may simply be removed from the shore module 202 and replaced with the bridge module 204 associated with the new component 130. After the new bridge module 204 and component 130 are connected to the shore module 202, the shore module 202 retrieves the command list 154 and dependencies 156 associated with the new bridge module 204 based on its unique identifier 152. In some examples, such as if the new vehicle component 130 is operable using the same MCU 232 as the old component 130, the old bridge module 204 may remain at the shore module 202 and be connected to the new component 130, with the shore module 202 and/or bridge module 204 reprogrammed with the command list 154 and dependency list 156 for the new component 130.

Further, power distribution is implemented with split responsibility between the shore module 202 and the bridge modules 204. The shore module 202 may be responsible for initial conditioning of the zonal controller 200 and monitoring of connection of the bridge modules 204. The bridge modules 204 may be responsible for final conditioning of the zonal controller 200 and monitoring to vehicle components 130. Both the shore module 202 and the bridge module 204 may operate to dynamically configure trip points using analog current measurement.

In reference to the example of the first zonal controller 200a being configured to control operation of one or more vehicular lighting modules 130 (e.g., front headlights and/or side markers), the user may plug or otherwise connect a vehicular lighting module 130 into the bridge module 204 associated with front exterior lighting. The MCU 232 of the bridge module 204 is specifically configured to be connected to those specific lighting modules 130. For example, the MCU 232 may be programmed to implement functions 154 given a specific set of SPI commands or dependencies 156, such as to turn on lights associated with daytime running lights when the relevant setting is selected. The list of SPI commands or dependencies 156 and associated functions or commands 154 may be stored on the cloud 150 for the shore module 202 to retrieve after identifying the bridge module 204 and/or light module 130. That is, after plugging the bridge module 204 into the shore module 202, the shore module 202 sends the request identifier SPI message to the bridge module 204 and the bridge module 204 responds with the unique identifier 152 (e.g., 0x01). Based on the unique identifier 152, the shore module 202 retrieves the list of commands 154 and associated dependencies 156 corresponding to the bridge module 204 and/or the vehicle components 130. After the shore module 202 retrieves the list of commands 154 and dependencies 156, the shore module 202 may operate without user intervention.

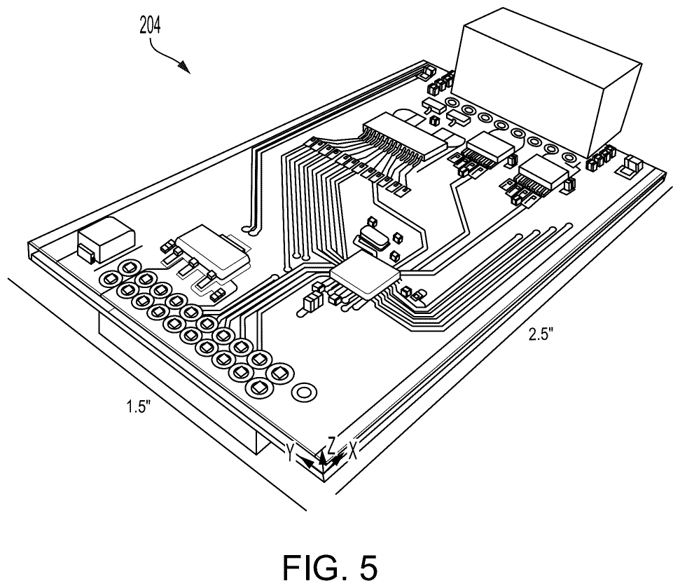

FIGS. 5-7 include example dimensions of the modular zonal controller 200. For example, each bridge module 204 may be accommodated on a PCB having a length of 2.5 inches and a width of 1.5 inches to provide total package dimensions including a length of the bridge module 204 of 2.65 inches, a width of 1.65 inches, and a depth of 0.6 inches. In the illustrated example, the PCB 206 of the shore module 202 may be configured to accommodate 11 or more bridge modules 204 for total package dimensions including a length of 8.5 inches, a width of 7.075 inches, and a depth of 1.05 inches.

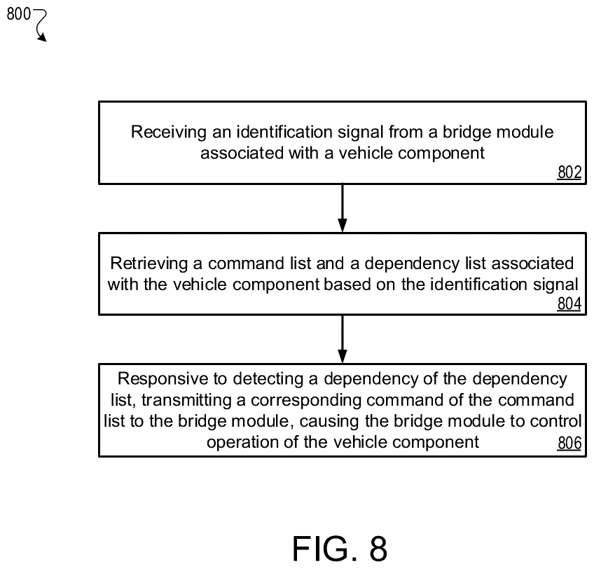

FIG. 8 is a flowchart for an exemplary arrangement of operations for a method 800 (interchangeably referred to as the ‘installation routine 800’) of configuring a zonal controller 200 when one or more bridge modules 204 with connected vehicle components 130 are installed at a shore module 202 of the zonal controller 200. The method 800 may execute on the data processing hardware 112 of one of the zonal controllers 200 (e.g., across the shore module 202 and one or more of the bridge modules 204) and/or on the data processing hardware 142 of the master controller 140 of FIG. 1, and based on instructions stored in the memory storage 114 of the zonal controller 200 (e.g., across the shore module 202 and one or more of the bridge modules 204) and/or the memory storage 144 of the master controller 140. At operation 802, the method 800 includes receiving the unique identifier or identification signal 152 from the bridge module 204 associated with one or more components 130 of the vehicle 100. The bridge module 204 may transmit the identification signal 152 responsive to receiving an identification request from the shore module 202, and the shore module 202 may transmit the identification request responsive to detecting installation of the bridge module 204 at the shore module 202. At operation 804, the method 800 includes retrieving the command list 154 and the dependency list 156 associated with the one or more vehicle components 130 responsive to receiving the identification signal 152. The command list 154 and the dependency list 156 may be retrieved, for example, from the remote server 150 or memory storage 114 of the zonal controller 200. Responsive to detecting a selected dependency of the dependency list 156, the method 800 includes at operation 806 transmitting a command of the command list 154 to the bridge module 204. The transmitted command corresponds to the selected dependency and causes the bridge module 204 to control operation of the one or more vehicle components 130. In some examples, detecting the selected dependency includes detecting a signal associated with the operation of the vehicle component 130 via the communication network of the vehicle 100.

Thus, the modular zonal controller 200 may split each zonal controller 200 into one shore module 202 and multiple small bridge modules 204. The shore module 202 contains the main processing and networking elements that handle connection to the vehicle network and distributing tasks to the relevant bridge modules 204. Bridge modules 204 contain application-specific hardware controlled by a basic MCU 232 that may act primarily as a SPI GPIO expander with additional functionality. The modular zonal controller 200 alleviates issues related to over-equipped zonal controllers and PCB space constraints by separating the processing and driving components of the controller 200. This allows the zonal controller 200 to fulfill content requirements for different vehicle zones and platforms by adding and/or removing driving components, and permits upgrades as the processing module and/or driving modules can be easily changed.

Moreover, by equipping a safety-critical bridge module 204 (e.g., a bridge module 204 associated with vehicle components 130 like airbag deployment, driving assistance systems, sensor systems, and the like) with redundant CAN-capable MCUs 232, the bridge module 204 will be able to continue functioning if any one MCU 232 fails or the shore module 202 fails. The safety backup CAN ring 214 allows other shore modules 202 of the vehicle 100 to continue controlling safety-critical bridge modules 204.

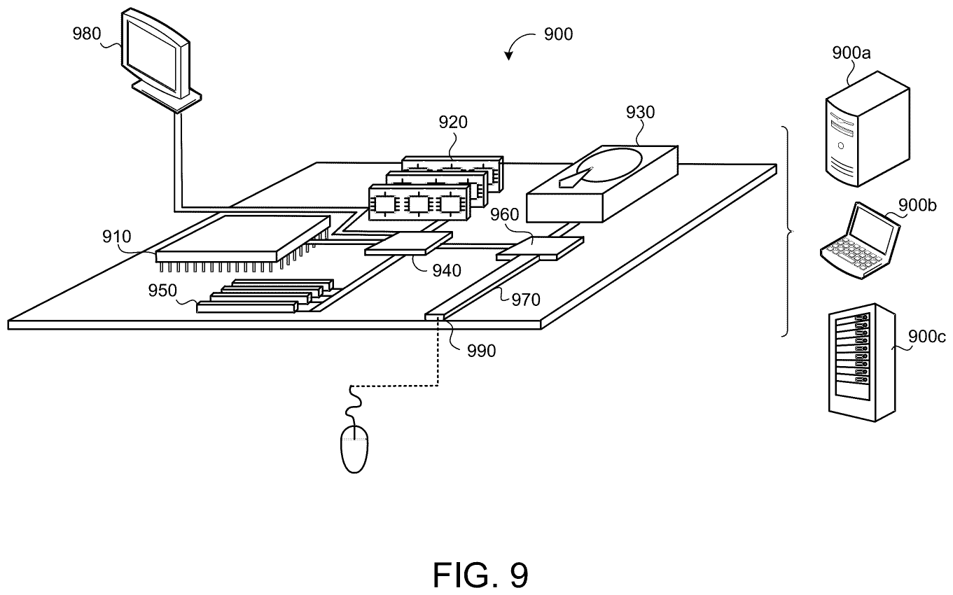

FIG. 9 is schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910, memory 920, a storage device 930, a high-speed interface/controller 940 connecting to the memory 920 and high-speed expansion ports 950, and a low speed interface/controller 960 connecting to a low speed bus 970 and a storage device 930. Each of the components 910, 920, 930, 940, 950, and 960, are interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high speed controller 940 manages bandwidth-intensive operations for the computing device 900, while the low speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers 900a, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
receiving an identification signal from a bridge module associated with a component of a vehicle;
responsive to receiving the identification signal, retrieving a command list and a dependency list associated with the component; and
responsive to detecting a selected dependency of the dependency list, transmitting a command of the command list corresponding to the selected dependency to the bridge module, the command when received by the bridge module causing the bridge module to control an operation of the component.

2. The method of claim 1, wherein the bridge module transmits the identification signal responsive to receiving an identification request from a shore module.

3. The method of claim 2, wherein the shore module transmits the identification request to the bridge module responsive to detecting installation of the bridge module at the vehicle.

4. The method of claim 2, wherein the bridge module comprises one bridge module of a plurality of bridge modules connected to the shore module.

5. The method of claim 4, wherein the shore module and the plurality of bridge modules connected to the shore module are operable to control operation of a respective set of components of the vehicle, each bridge module of the plurality of bridge modules associated with one or more of the components of the respective set of components.

6. The method of claim 5, wherein the shore module is assigned to a respective zone of the vehicle and the respective set of components of the vehicle controlled by the bridge module and the plurality of bridge modules are installed at or near the respective zone of the vehicle that the shore module is assigned.

7. The method of claim 1, wherein retrieving the command list and the dependency list comprises retrieving the command list and the dependency list wirelessly from a remote server.

8. The method of claim 1, wherein detecting the selected dependency comprises detecting a signal associated with the operation of the component on a communication network of the vehicle.

9. The method of claim 1, wherein the bridge module is connected to a communication network of the vehicle.

10. The method of claim 1, wherein the bridge module comprises a microcontroller unit (MCU) operable to control the operation of the component.

11. A vehicle comprising:
memory hardware storing instructions that, when executed on data processing hardware in communication with the memory hardware, cause the data processing hardware to perform operations comprising:
receiving an identification signal from a bridge module associated with a component of a vehicle;
responsive to receiving the identification signal, retrieving a command list and a dependency list associated with the component; and
responsive to detecting a selected dependency of the dependency list, transmitting a command of the command list corresponding to the selected dependency to the bridge module, the command when received by the bridge module causing the bridge module to control an operation of the component.

12. The vehicle of claim 11, wherein the bridge module transmits the identification signal responsive to receiving an identification request from a shore module.

13. The vehicle of claim 12, wherein the shore module transmits the identification request to the bridge module responsive to detecting installation of the bridge module at the vehicle.

14. The vehicle of claim 12, wherein the bridge module comprises one bridge module of a plurality of bridge modules connected to the shore module.

15. The vehicle of claim 14, wherein the shore module and the plurality of bridge modules connected to the shore module are operable to control operation of a respective set of components of the vehicle, each bridge module of the plurality of bridge modules associated with one or more of the components of the respective set of components.

16. The vehicle of claim 15, wherein the shore module is assigned to a respective zone of the vehicle and the respective set of components of the vehicle controlled by the bridge module and the plurality of bridge modules are installed at or near the respective zone of the vehicle that the shore module is assigned.

17. The vehicle of claim 11, wherein retrieving the command list and the dependency list comprises retrieving the command list and the dependency list wirelessly from a remote server.

18. The vehicle of claim 11, wherein detecting the selected dependency comprises detecting a signal associated with the operation of the component on a communication network of the vehicle.

19. The vehicle of claim 11, wherein the bridge module is connected to a communication network of the vehicle.

20. The vehicle of claim 11, wherein the bridge module comprises a microcontroller unit (MCU) operable to control the operation of the component.
